(19) United States
(12) Patent Application Publication
(10) Pub. No.: US 2011/0000569 A1
(43) Pub. Date: Jan. 6, 2011

(54) Fabric Air Duct with Flexible Support Ribs

(76) Inventors: Phil Lynch, Chattanooga, TN (US); Clemmey Queen, Sylve, NC (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 12/825,954

(22) Filed: Jun. 29, 2010

Related U.S. Application Data
(60) Provisional application No. 61/221,426, filed on Jun. 29, 2009.

(51) Int. Cl. F16L 3/01; F16L 11/00

(52) U.S. Cl. 138/107; 138/118

(57) ABSTRACT

A flexible fabric tube is provided for heating, ventilation and air conditioning use having batten pockets longitudinally spaced and extending circumferentially around the tube and having flexible support members therein to maintain the tube in an open position.

### FIELD OF THE INVENTION

The present invention relates to flexible air ducts, and more specifically, to a method for maintaining the lumen of a flexible air duct in open position.

### BACKGROUND OF THE INVENTION

Duct work used in connection with heating, ventilating and air conditioning systems is often formed of rigid metal, such as steel or aluminum. Flexible metallic ducts may be utilized in home buildings where they generally rest upon an attic ceiling. However, in warehouses, manufacturing plants, agricultural buildings, and many other structures, the ducts are suspended from the roof or ceiling and are thus exposed. For functional and economic reasons, it may be desirable to utilize flexible fabric ducts in these buildings. These fabric ducts typically have a flexible fabric wall that inflates to a generally cylindrical shape by pressure of the air being conveyed through the duct. Fabric ducts are relatively inexpensive and seem to inhibit the formation of condensation. In addition, the porosity of fabric and the ease of locating additional ventilation openings along the length of fabric duct work, allows fabric duct work to broadly and evenly disperse air throughout the room or building being conditioned or ventilated.

In many cases, once the air supply fan for a room or building is turned off, the resulting loss of air pressure in the duct deflates the fabric tube causing it to sag. The sagging creates an unattractive appearance and when the duct is reinflated, the duct can create a visual movement and audible popping sounds as it becomes taunt.

A number of efforts have been made to eliminate or reduce the sagging and popping noises and to achieve this goal, some inflatable ducts include a structure that helps hold a deflated duct in a generally expanded shape. Examples of ducts supported in such a manner are disclosed in U.S. Pat. No. 6,280,320 and U.S. Pat. No. 3,357,088. A significant drawback of these systems is the amount of supporting hardware necessary to keep the duct expanded. U.S. Publication 2008/0113610 discloses another attempt to maintain the shape of a fabric air duct when not being filled with pressure from an air supply fan, in the nature of hangers that attach to each side of the fabric duct and possibly also in the center top. While an improvement over prior systems, this latest published invention also requires substantial hardware and many attachments of the fabric duct to the suspension system.

### BRIEF DESCRIPTION OF THE INVENTION

Therefore, it is an objective of the invention to provide an inexpensive, lightweight and simple method to maintain the lumen of fabric ductwork in an open position. This may be accomplished by adding a batten pocket around the circumference of the fabric tube and utilizing a support member, such as a length of polypropylene tubing, within the batten pocket to maintain the shape of the lumen even in the absence of air pressure from a ventilation blower.

### BRIEF DESCRIPTION OF THE DRAWINGS

FIG. 1 is a sectional view of a fabric duct tube suspended by a single connector at a top central portion of the tube, depicting the tube in its inflated and circular shape.

FIG. 2 is an illustration of the fabric tube of FIG. 1 in a deflated state when no air pressure is applied.

FIG. 3 is an illustration of a prior art support hanger that attempts to maintain an open lumen in a fabric duct tube by utilizing multiple exterior fastening positions.

FIG. 4 is an illustration of a fabric duct tube with only two external supports.

FIG. 5 is a perspective view of a fabric duct tube having a batten pocket according to the present invention.

FIG. 6 is an enlarged view of the opening of a batten pocket and a plastic tube support member according to the present invention.

FIG. 7 is a side sectional view of a fabric duct according to the invention.

FIG. 8 is an enlarged sectional view of a batten pocket on a fabric duct tube according to the present invention.

FIG. 9 is a sectional view of a fabric duct according to the invention.

FIG. 10 is a top plan view of an alternative batten pocket design with a fold down corner.

FIG. 11 illustrates a commercial embodiment of a fabric tube according to the invention.

### DETAILED DESCRIPTION OF THE INVENTION

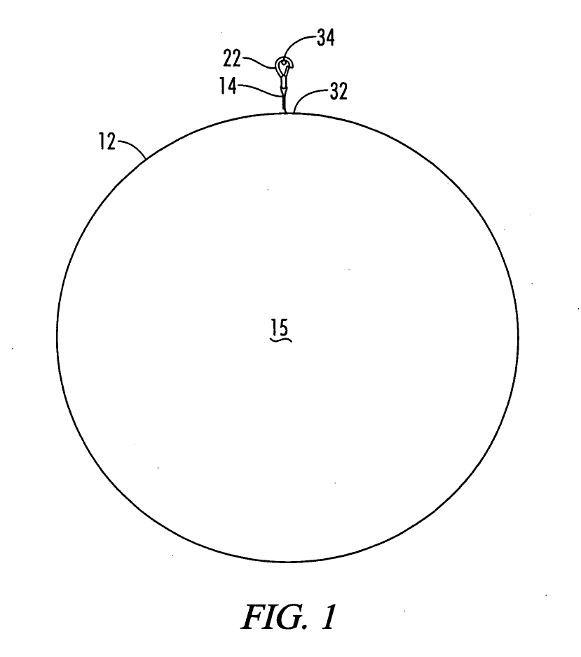

Referring to FIG. 1, prior art fabric tube 12 is illustrated with a top central portion 32 and a top hanger mechanism consisting of fabric strap 14, connector 22, and overhead suspension line 34. The tube 12 is shown in its fully inflated state as when an air blower is causing ventilating air to pass through lumen 15 of the tube 12.

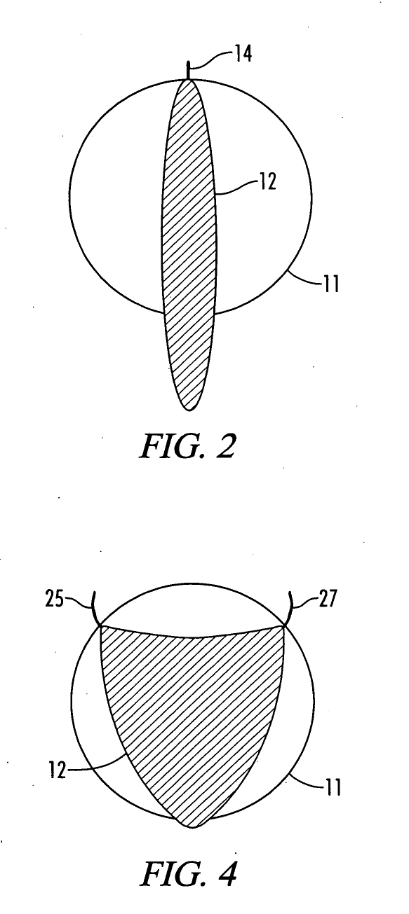

FIG. 2 depicts the fabric tube 12 of FIG. 1 when the ventilating fan is de-energized and the tube collapses due to the absence of air pressure. Phantom circle 11 illustrates the position occupied when the ventilating fan is energized and air pressure fills the lumen of tube 12.

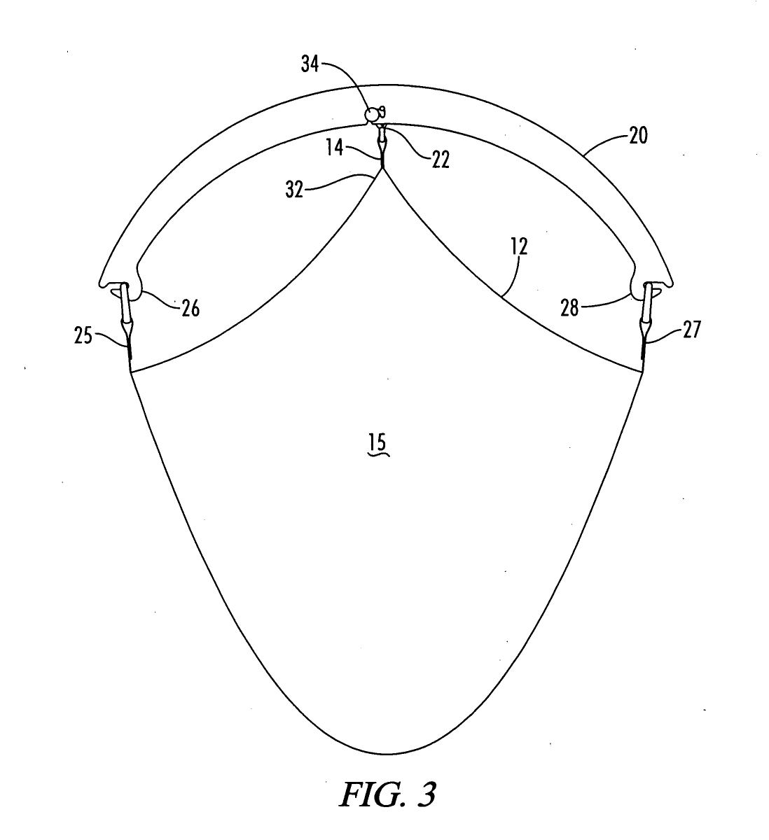

FIG. 3 depicts the structure of prior art U.S. Publication 2008/0113610 in which a fabric tube 12 has a support 14 at the top center 32 and also has a support strap 25 on the left side and second support strap 27 on the right side which are attached to hanger 20 at left side 26 and right side 28. A central portion 30 of hanger 20 may be received directly on suspension line 34 and the side straps 25, 27 and center strap 14, may be longitudinally offset from hanger 20.

FIG. 4 illustrates the deflated configuration of tube 12 when a tube is supported only by left and right suspension straps 25, 27, typically from left and right suspension lines, while phantom circle 11 illustrates the inflated circumference of the tube.

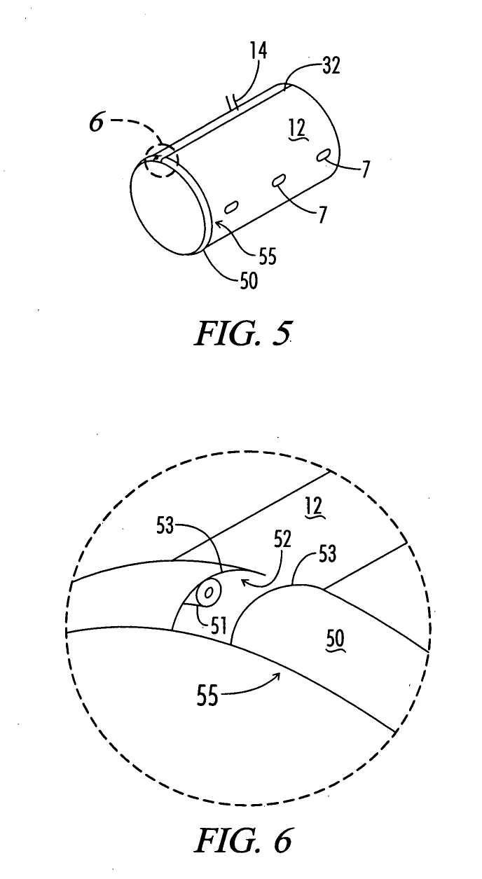

Turning then to the present invention, FIG. 5 shows a perspective view of fabric tube 12 having air vents 7 for ventilation, support strap 14 extending upward to a suspension line (not shown) from a top central portion 32 of the tube and batten pocket 55. As shown in detail in FIG. 6, batten pocket 55 may be formed by attaching a fabric strap 50 around the circumference of a fabric tube 12 creating a pocket space 52 into which support member, such as plastic tube 51 may be inserted. In the illustrated embodiments, edges 53 of batten pocket 55 are finished in a straight line and spaced apart from each other by about 1-2 inches.

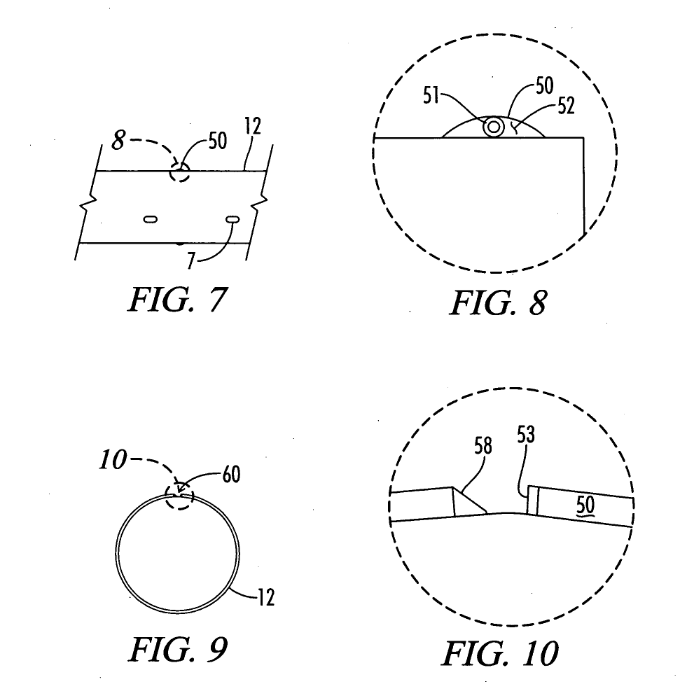

FIG. 7 illustrates a longitudinal sectional view of fabric tube 12 with ventilation openings 7 and batten pocket 55. A detailed view of batten pocket 55 is shown in FIG. 8 with the opening 52 within batten pocket 55 filled by plastic tube 51. A side sectional view of tube 12 in FIG. 9 highlights the opening 60 at the top central portion of tube 12. In the embodiment of the opening section shown in FIG. 10, one side of the batten pocket 55 is finished with a straight end 53 while the other side 58 is finished with a folding corner to facilitate entry of the support member such as plastic tube 51 within the pocket. The top central portion and folding corner may be fitted with hook and loop fastening material to secure the plastic tube 51 in the pocket space 52.

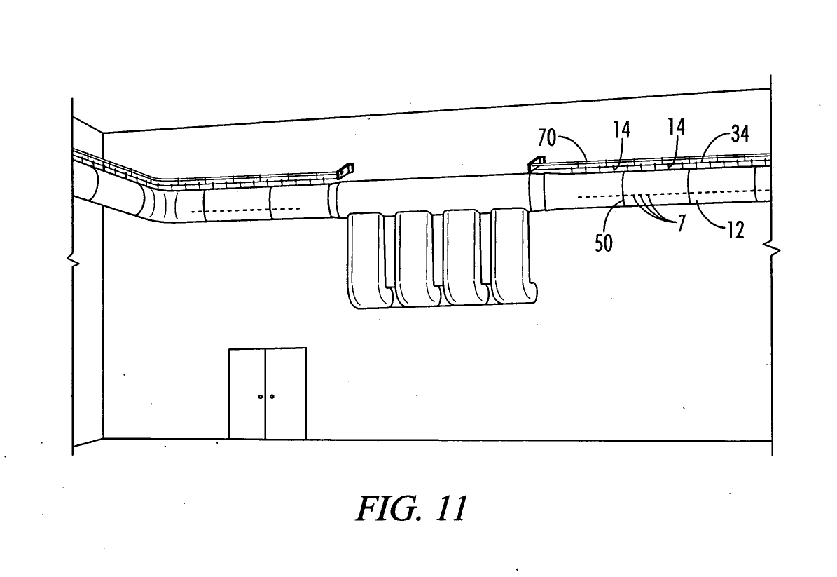

FIG. 11 illustrates a commercial embodiment of fabric tube 12 with ventilation tube opening 7 and batten pockets 55. The support straps 14 extend upward from the top center portion of the tube to suspension line 34. Suspension line 34 is in turn supported by guide rail 70.

The batten pocket 55 is advantageously performed by simply sewing or otherwise fastening a strip of cloth 50 around the outside of the diameter of the fabric duct work to form a pouch 52 that is preferably accessible from the top center portion 32 of the fabric duct 12. The insertion of an appropriate length of plastic tubing, ideally of a length to completely encircle the outer circumference of the fabric duct work and provide an overlap sufficient to permit each end to entirely cross the opening section in the top center and be concealed within the batten pocket on the opposite side, provides sufficient rigidity to maintain the lumen 15 in a generally circular shape. Thus, plastic tubing having a length of about 6 inches or more in excess of the circumference of the outer diameter of the inflated duct work is desirable. The presently preferred support element for the batten pocket is polypropylene tubing having a diameter between about 1/4^{th} inch and 1/2 inch (preferably 3/8^{th} inches), thereby providing sufficient flexibility to insert into the pouch and form a circular configuration while having sufficient rigidity to hold the fabric duct open in a substantially circular state when no ventilating air pressure is present. The fabric or material utilized to form the batten pocket is typically the same fabric as the duct work, however, it may be made of different material or color in order to provide visual contrast. The support member need not be tubing but may also be a solid rod or shape having the desired flexibility, stiffness and resilience.

The result of the invention is provide fabric duct work with improved aesthetics, easier installation, and smoother start ups through the absence of inflation movement and audible pop. This allows for smoother and quieter inflation upon equipment startup and avoids the necessity of unusual hanger structures and multiple attachment points around the circumference of the tubing.

We claim:

1. An inflatable air duct assembly substantially show and described.

2. An air duct assembly comprising:
(a) an inflatable tube defining a lumen for the passage of air;
(b) a support line centrally disposed over the inflatable tube;
(c) a plurality of hangers attaching top central portion of the inflatable tube to the support line; and
(d) a plurality of batten pockets extending circumferentially around the inflatable tube and having a flexible support member therein.
